(19) United States
(12) Patent Application Publication
(10) Pub. No.: US 2016/0266304 A1
(43) Pub. Date: Sep. 15, 2016

(54) LIGHT-GUIDING DEVICE AND SYSTEM THEREOF FOR RECEIVING THE LIGHT SOURCES OF DIFFERENT ANGULAR DISTRIBUTION AND EMITTING THE SPATIALLY UNIFORM LIGHT IN THE CORRESPONDING DIRECTION

(71) Applicant: National Taiwan Normal University, Taipei (TW)

(72) Inventors: Tun-Chien Teng, Taipei (TW); Li-Wei Tseng, Taipei (TW)

(21) Appl. No.: 14/642,386

(22) Filed: Mar. 9, 2015

(51) Int. Cl. F21V 8/00

(52) U.S. Cl. CPC G02B 6/0076; G02B 6/0055; G02B 6/0065; G02B 6/0061; G02B 6/0068; G02B 6/009

(57) ABSTRACT

A light-guiding device includes a microstructure layer, a plurality of light-guiding layers and a plurality of intermediary layers. The microstructure layer includes a plurality of microstructure devices. The light-guiding layers are stacked on the microstructure layer. And the intermediary layers are configured on the corresponding light-guiding layer. Furthermore, a reflective index of the light-guiding layer is greater than a reflective index of the upper intermediary layer, one side plane of the light guiding layers defines a inputting-light plane.

### BACKGROUND OF THE INVENTION

1. Field of the Invention

The present invention is related to a light-guiding device. More particularly, the present invention is related to a light-guiding device for receiving the light sources of different angular and emitting the spatially uniform light in the corresponding direction.

2. Description of the Prior Art

The currently backlighting module of planner monitor is an element that transferred the point light source to the uniformed planner light source. Then the backlighting light source outputted by the backlighting module need to be filtered and be transmitted to the panel via a color filter. However, all of the color filters of present technology are absorption filter, and the property of absorption filter is easily reducing the energy of the backlighting source.

Therefore, providing a technical means without color filter to reduce energy loss of backlight light source is a technical issue which needs to be solved in the technical field.

### SUMMARY OF THE INVENTION

To solve the previous technical problems, one objective of the present application is providing a light-guiding device that can receive the light sources of different angular and emit the spatially uniform light in the corresponding direction.

To achieve the aforementioned objective, the present application provides a light-guiding device. The light-guiding device comprises a microstructure layer, a plurality of light-guiding layers and a plurality of intermediary layers. The microstructure layer comprises a plurality of microstructure devices. The light-guiding layers are stacked on the microstructure layer. And the intermediary layers are configured on the corresponding light-guiding layer. Furthermore, a reflective index of the light-guiding layer is greater than a reflective index of the upper intermediary layer, one side plane of the light guiding layers defines a inputting-light plane.

To achieve the aforementioned objective, the present application provides a light-guiding system. The light-guiding system comprises aforementioned light-guiding device, and a plurality of light source guiding devices, each light source guiding device match the corresponding light-guiding layer.

Therefore, the light-guiding device of present application is able to receive the light sources of different angular and emit the spatially uniform light in the corresponding direction so as to replace the color filter and prevail the technical problem of prior art.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1A shows a sectional view of light-guiding device of first embodiment of the present application.

FIG. 1B shows a perspective view of light-guiding device of first embodiment of the present application.

FIG. 2 shows an operating diagram of one light-guiding layer light-guiding device of the present application.

FIG. 3 shows an operation diagram of three light-guiding layer of the light-guiding device of the present application.

FIG. 4 shows the illuminance distribution on the outputting-light plane of the light-guiding device.

FIG. 5 shows the angular distribution of the luminous intensity on the outputting-light plane of the light-guiding device.

FIG. 6 shows an operating diagram of light-guiding device of second embodiment of the present application.

FIG. 7 shows a structure diagram of light source guiding device of light-guiding system of third embodiment of present application.

FIG. 8 shows a system diagram of light-guiding system of third embodiment of present application.

FIG. 9 shows a system diagram of light-guiding system of forth embodiment of present application.

### DETAILED DESCRIPTION OF THE PREFERRED EMBODIMENT

The following description is about embodiments of the present invention; however it is not intended to limit the scope of the present invention.

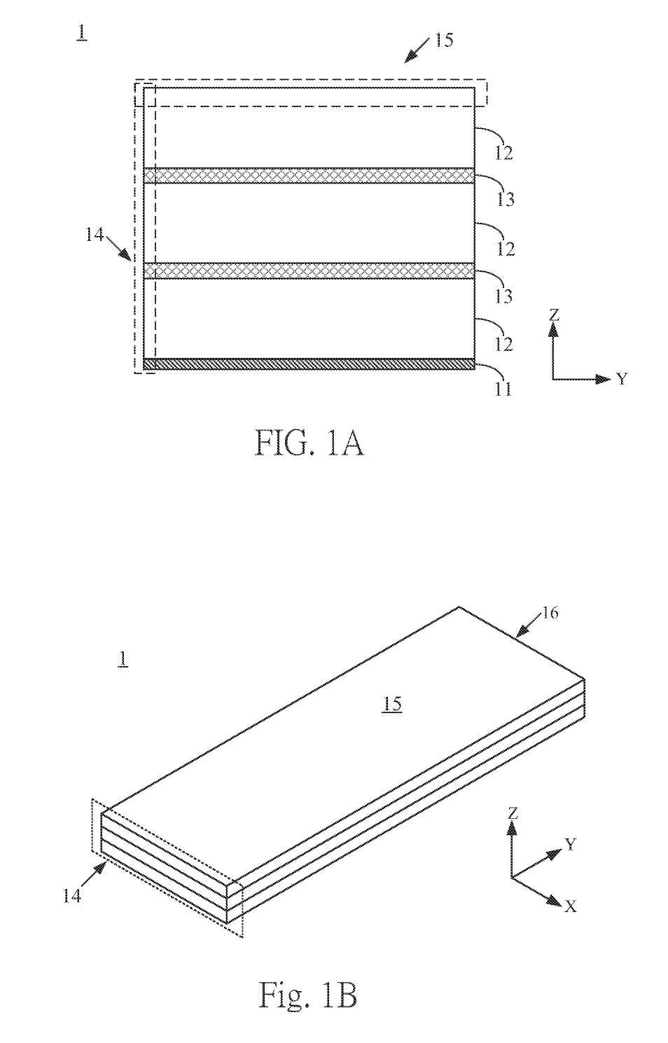

FIG. 1A shows a sectional view of light-guiding device 1 of first embodiment of the present application. FIG. 1B shows a perspective view of the light-guiding device 1 of the present application. The light-guiding device 1 comprises a microstructure layer 11, a plurality of light-guiding layers 12, and a plurality of intermediary layers 13. The microstructure layer 11 comprises a plurality of microstructure devices. The light-guiding layers 12 are stacked on the microstructure layer 11. Each the intermediary layer 13 is configured on the corresponding light-guiding layer 12. Wherein, one side plane of the light-guiding layers 12 defines an inputting-light plane 14 (x-z plane, FIG. 1B), the plane of the light-guiding layers 12 away from the microstructure layer 11 defines a outputting-light plane 15 (x-y plane, FIG. 1B), and a reflective index of the light-guiding layer 12 is greater than a reflective index of the upper intermediary layer 13 so as to form a total reflection condition. The shape of light-guiding device 1 is selected from flatted plate shape, curved plate shape or wedge shape. However, the shape of light-guiding device 1 is not limited by the aforementioned shapes.

The aforementioned intermediary layer 13 is used to bind two light-guiding layers 12, and the material thereof can adopt optical glue. The aforementioned microstructure device could adopt v-type groove, trapezoidal type groove, inversed trapezoidal type groove, or inverted triangle groove . . . etc. In other embodiment, the light-guiding device 1 further coats a reflective layer on the bottom plane of the microstructure layer 11.

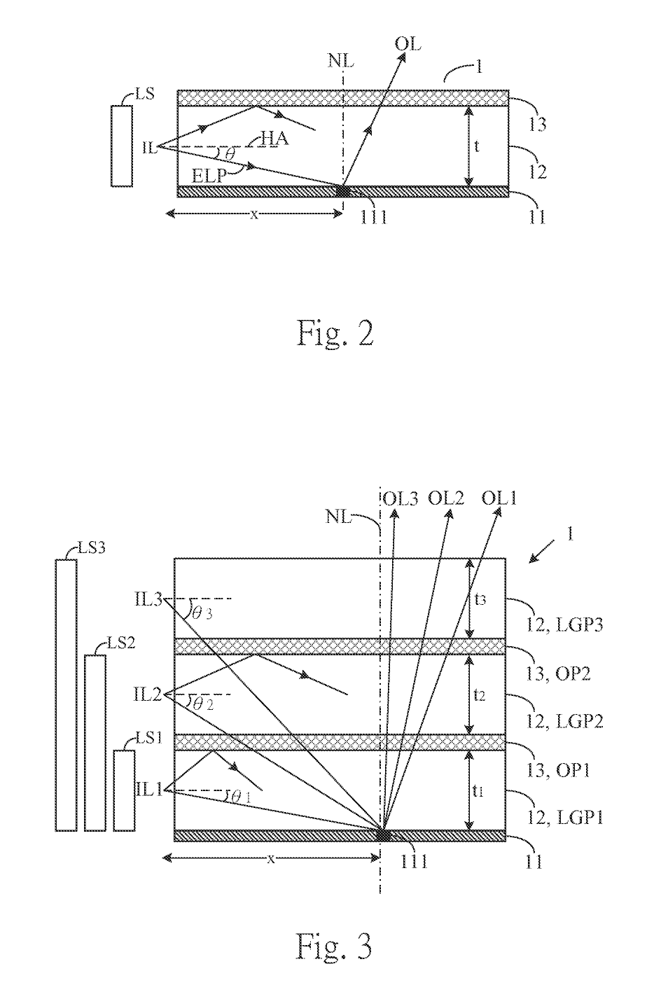

FIG. 2 shows an operating diagram of one layer light-guiding device 1 of present application and explains how to design the thickness (t) of the light-guiding layer 12 and opening angular θ of the inputting light. The thickness (t) is substantially expressed as following equation:

$$\frac{t}{x} = tan θ \qquad eq ( 1 )$$

The opening angular θ is between entering light path (ELP) and the horizontal axis (HA), x denotes a distance substantially from the inputting-light plane 14 to a position of one of the microstructure device 111.

When the light-guiding layer 12 received the IL, portion of the IL transmits to the microstructure layer 11, hits the microstructure device 111, and reflects or refracts to the outputting-light plane 15. The total reflection plane formed by light-guiding layer 12 and the intermediary layer 13 reflects other portion IL to microstructure layer 11 so as to avoid the inputting light IL directly pass through the intermediary layer 13 without hit the microstructure layer 11.

FIG. 3 shows an operating diagram of three layer light-guiding device 1 of the present application. In order to make ILs (IL1˜IL3) which have different opening angular to hit approximately microstructure device 111, preset application uses the eq (1) to select the opening angular θ, x, and t of each light-guiding layer 12. In present application, first we set up x is a constant, and based on x to calculate θ₁ and t₁. Next, we based on x, θ₁ and t₁ design thickness (t₂,t₃) and opening angular (θ₂,θ₃) of other light-guiding layers 12 (LGP2, LGP3). For providing the optimal performance, the aforementioned parameters of the light-guiding device 1 could be adjusted or fine-tuned based on the eq (1). The aforementioned parameters of each layer are derived by following equations:

$$\begin{matrix}\frac{{t}_{1}}{x} = tan {θ}_{1} & eq ( 2 ) \\ \frac{{t}_{2} + {t}_{1} + {OP}_{1}}{x} = tan {θ}_{2} & eq ( 3 ) \\ \frac{{t}_{3} + {t}_{2} + {t}_{1} + {OP}_{1} + {OP}_{2}}{x} = tan {θ}_{3} & eq ( 4 )\end{matrix}$$

OP1 denotes thickness of the intermediary layer between the first light-guiding layer (LGP1) and the second light-guiding layer (LGP2). And the OP2 denotes thickness of the intermediary layer between the second light-guiding layer (LGP2) and the third light-guiding layer (LGP3).

The following two tables (Table 1, Table 2) show the setting parameters of two embodiment of the light-guiding device 1.

TABLE 1
(θ₁, θ₂, θ₃) = (5°, 13°, 21°)

| | LGP1 | LGP2 | LGP3 | OP1 | OP2 |
|---|---|---|---|---|---|
| Thickness (mm) | 1 | 1.67 | 1.86 | 0.05 | 0.05 |
| Reflective index | 1.49 | 1.49 | 1.49 | 1.47 | 1.44 |

TABLE 2
(θ₁, θ₂, θ₃) = (10°, 18°, 26°)

| | LGP1 | LGP2 | LGP3 | OP1 | OP2 |
|---|---|---|---|---|---|
| Thickness (mm) | 1 | 0.85 | 0.95 | 0.05 | 0.05 |
| Reflective index | 1.49 | 1.49 | 1.49 | 1.45 | 1.4 |

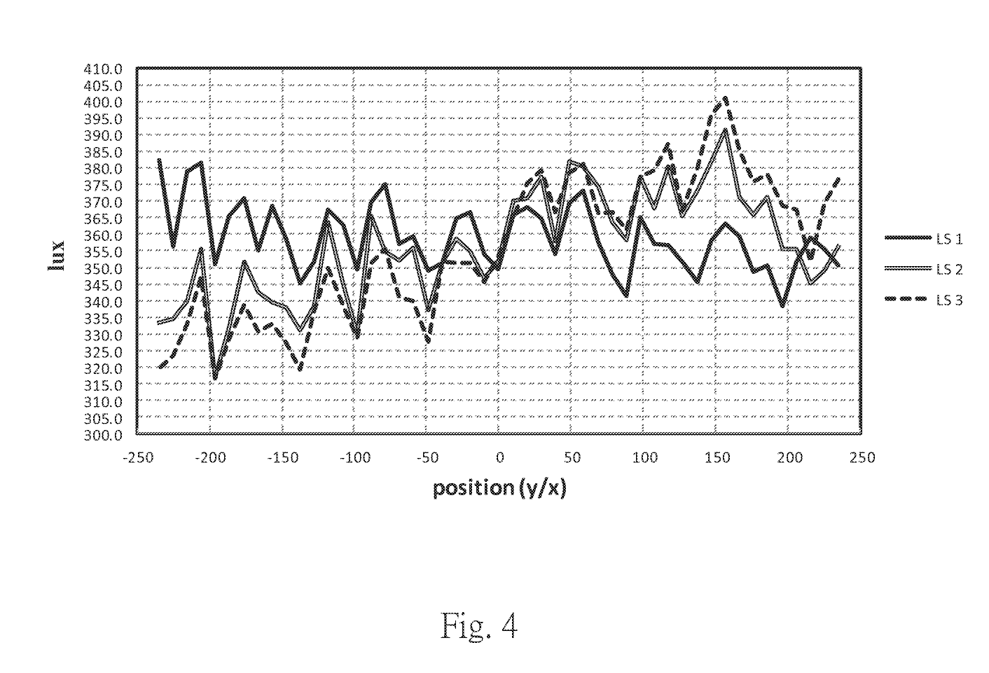

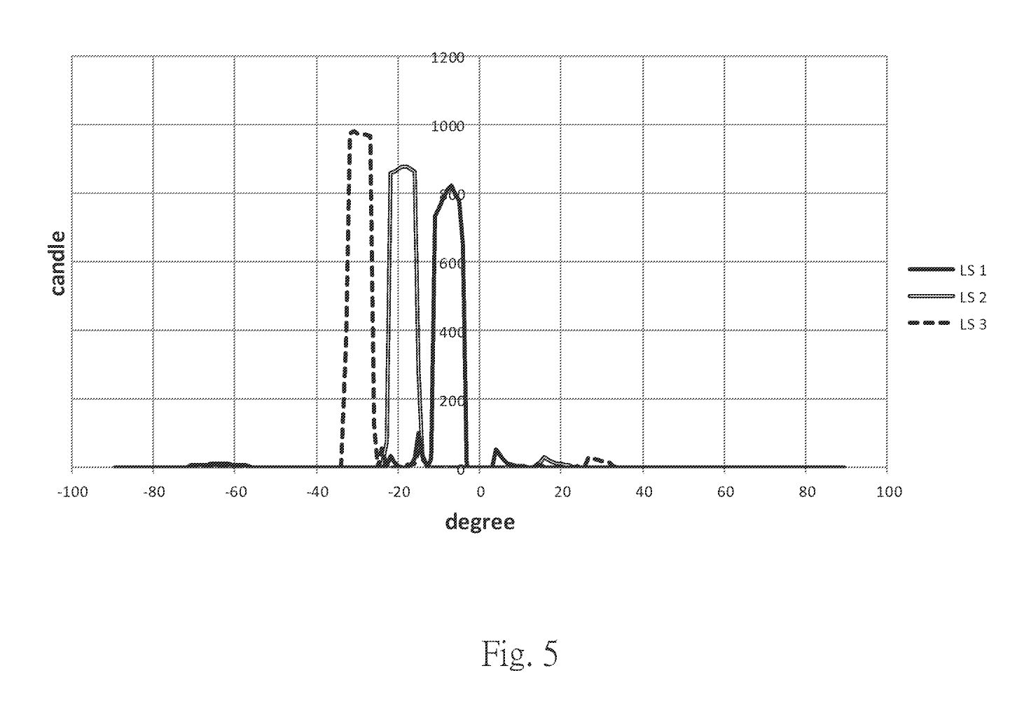

FIGS. 4 and 5 show the simulation result of the light-guiding device 1. FIG. 4 shows the illuminance distribution on the outputting-light plane 15 of the light-guiding device 1 when switch on light source LS1, LS2, and LS3 at the same time. FIG. 5 shows the angular distribution of the luminous intensity on the outputting-light plane 15 of the light-guiding device 1 when switch on light source LS1, LS2, and LS3 at the same time. The aforementioned simulation result proofs that the light-guiding device 1 can receive the light sources of different angular and emits the spatially uniform light in the corresponding direction.

In present embodiment, the microstructure device 111 distribution density is varied along the y axis direction (that is, from the inputting-light plane 14 to the terminal end 16), therefore the variation of energy distribution also along the y axis direction.

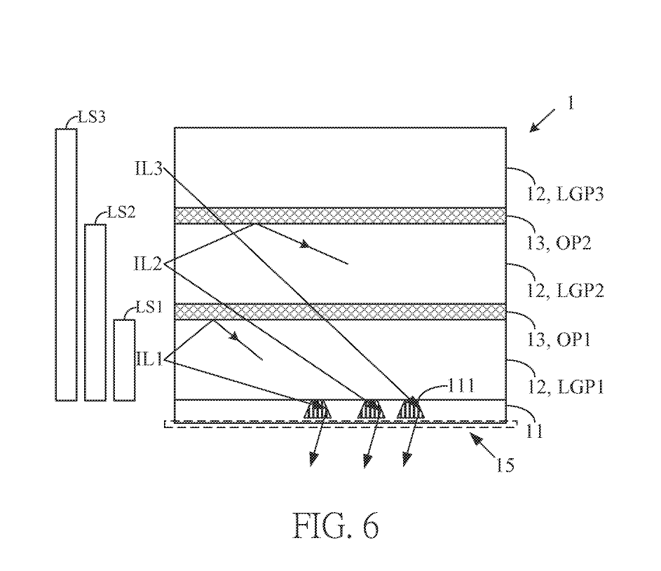

FIG. 6 shows an operation diagram of light guiding device 1 of second embodiment of present application. The second embodiment is similar with the first embodiment, and the difference between first embodiment and second embodiment is that the outputting-light plane 15 of second embodiment is neighboring with the microstructure layer 11. In another embodiment, the microstructure device 111 of second embodiment is trapezoidal type groove. When the inputting light IL incident to the microstructure layer 11, the inputting light IL could be reflected or refracted by the inclined plane of the trapezoidal type groove and outputs to the outputting plane 15.

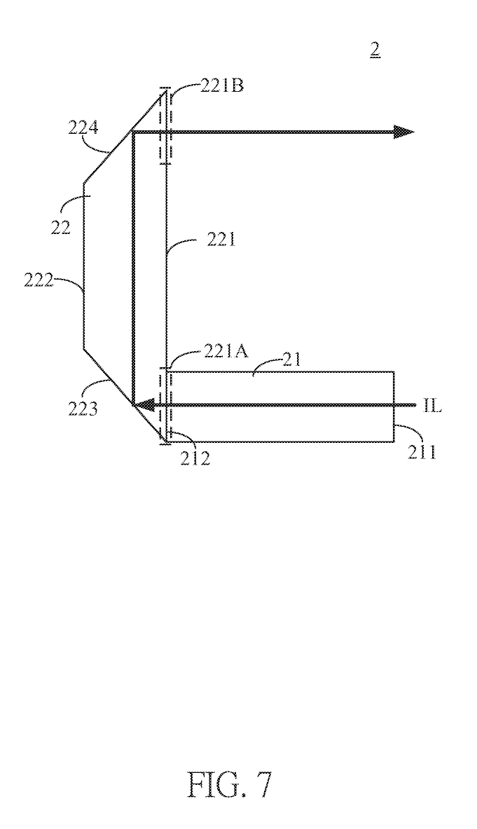

To explain how to provide the light source such as LS1, LS2 and LS3, present application discloses a light source guiding device 2 as shown in FIG. 7. The light source guiding device 2 comprises a compound parabolic concentrator (CPC) 21 and coupling prism (CP) 22. The CPC 21 comprises an inputting end 211 and connecting end 212. The CP 22 is a trapezoid shape prism, and comprises a bottom plane 221, top plane 222, first inclined plane 223, and second inclined plane 224. The connecting end 212 connected with inputting portion 221A of CP 22. And the light source guiding device 2 further forms a light path via the inputting end 211, connecting end 212, inputting portion 221A, first inclined plane 223, second inclined plane 224, and outputting portion 221B. The enter direction of the inputting light IL is opposite to an export direction of the lighting path. The first inclined plane 223 and second inclined plane 224 is configured to guide the inputting light IL to the specific microstructure device 111 by adjusting the inclined angle of the inclined plane. In one embodiment, the inclined angle is approximately to 45 degree.

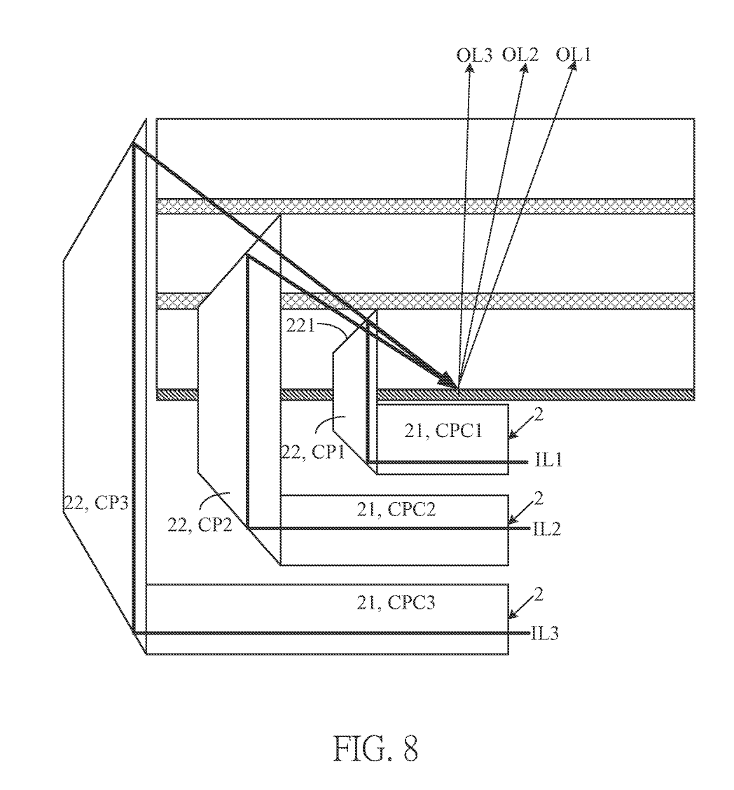

FIG. 8 shows a system diagram of light-guiding system of third embodiment of present application. The system comprises aforementioned light-guiding device 1 and a plurality of light source guiding devices 2, each light source guiding device 2 matches the corresponding light-guiding layer 12. In FIG. 8, the outputting portion 221B of CP 22 is embedded in the corresponding light-guiding layers 12. In other embodiment, the second inclined plane 224 further comprises a coating configured to reflect inputting light IL from the corresponding input end, and allows the other inputting light pass away from the other inputting end. Further explanation, when the IL1, IL2, and IL3 having different wavelength light (red light, green light, or blue light) and the second inclined plane 221 of CP1 configured a coating which can reflect IL1 and allows IL2 and IL3 pass through.

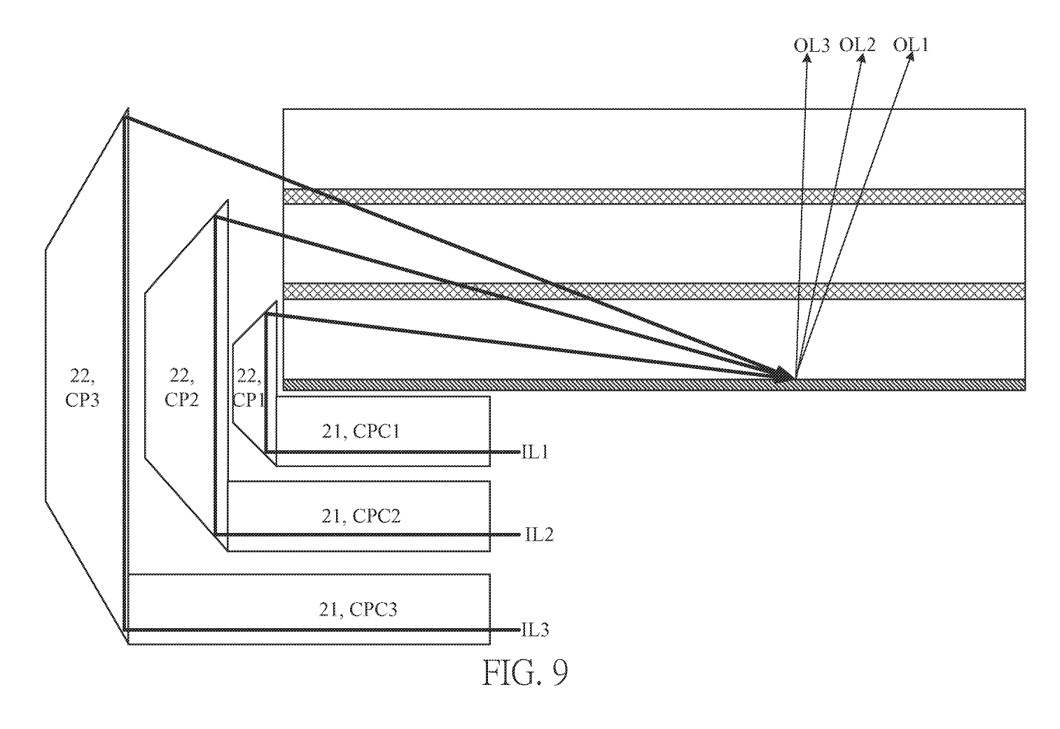

FIG. 9 shows a system diagram of light-guiding system of forth embodiment of present application. The forth embodiment is similar with the third embodiment. And the difference between the forth embodiment and third embodiment is that the outputting portion 221B of CP 22 is neighboring to the inputting-light plane 14.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light-guiding device, comprising:
a microstructure layer, comprising a plurality of microstructure devices;
a plurality of light-guiding layers, stacked on the microstructure layer; and
a plurality of intermediary layers, configured on the corresponding light-guiding layer;
wherein a reflective index of the light-guiding layer is greater than a reflective index of the upper intermediary layer;
wherein one side plane of the light guiding layers defines a inputting-light plane.

2. The device as claimed in claim 1, wherein a plane of the light-guiding device away from the microstructure layer defines an outputting-light plane.

3. The device as claimed in claim 1, wherein a plane of the light-guiding device neighboring with microstructure layer defines an outputting-light plane.

4. The device as claimed in claim 1, wherein one of the light-guiding layers is forming a total reflection condition with the upper intermediary layer.

5. The device as claimed claim 1, wherein a thickness (t) of the selected light-guiding layer is substantially expressed as following equation:
$$\frac{t}{x} = tan θ$$
wherein, x denotes a distance from the inputting-light plane to a position of one of the microstructure device, θ denotes an angle between an entering light path of the selected light-guiding layer and a horizontal axis.

6. The device as claimed in claim 1, wherein a first thickness (t₁) of the first light-guiding layer above the microstructure layer is substantially expressed as following equation:
$$\frac{{t}_{1}}{x} = tan {θ}_{1}$$
wherein, θ₁ denotes an angle between a first entering light path of first light-guiding layer and a horizontal axis.

7. The device as claimed in claim 6, wherein a second thickness (t₂) of the second light-guiding layer above the first light-guiding layer is substantially expressed as following equation:
$$\frac{{t}_{2} + {t}_{1} + {OP}_{1}}{x} = tan {θ}_{2}$$
wherein, θ₂ denotes an angle between an second entering light path and the horizontal axis, OP₁ denotes thickness of the intermediary layer between the first light-guiding layer and the second light-guiding layer.

8. The device as claimed in claim 7, wherein a third thickness (t₃) of the third light-guiding layer above the second layer is substantially expressed as following equation:
$$\frac{{t}_{3} + {t}_{2} + {t}_{1} + {OP}_{1} + {OP}_{2}}{x} = tan {θ}_{3}$$
wherein, θ₃ denotes an angle between a third entering light path of the third light-guiding layer and the horizontal axis, OP2 denotes thickness of the intermediary layer between the second light-guiding layer and the third light-guiding layer.

9. The device as claimed in claim 1, wherein a material of the intermediary layers is optical glue.

10. The device as claimed in claim 1, wherein a shape of the microstructure device is a v type groove.

11. The device as claimed in claim 1, wherein a shape of the microstructure device is a trapezoidal type groove.

12. The device as claimed in claim 1, further comprising a reflective layer coated on the microstructure layer.

13. The device as claimed in claim 10, wherein the reflective layer is coated on bottom plane of the microstructure layer.

14. The device as claimed in claimed 1, wherein the other side of the light-guiding layers defines a terminal end, and a distribution density of the microstructure devices is varied along the direction from the inputting-light plane to the terminal end.

15. A light-guiding system, comprising:
a light-guiding device as claimed in claim 1; and
a plurality of light source guiding devices, each light source guiding device match the corresponding light-guiding layer.

16. The light-guiding system as claimed in claim 15, wherein the each light source device comprises a inputting portion, an outputting portion, first inclined plane, and second inclined plane, the inputting portion, the outputting portion, the first inclined plane, and the second inclined plane forms a lighting path.

17. The light-guiding system as claimed in claim 16, wherein the outputting portion of the each light source device is embedded in the corresponding light-guiding layer.

18. The light-guiding system as claimed in claim 16, wherein the second inclined plane comprises a coating configured to reflecting a first inputting light from the corresponding input portion, and allows a second inputting light pass away from the inputting portion of the other light source guiding device.

19. The light-guiding system as claimed in claim 16, wherein, an enter direction of the lighting path is opposite to an export direction of the lighting path.

20. The light-guiding system as claimed in claim 19, wherein an inclined angle of the first inclined plane or the second inclined plane is approximately to 45 degree.
